(19) United States
(12) Patent Application Publication
(10) Pub. No.: US 2005/0278995 A1
(43) Pub. Date: Dec. 22, 2005

(54) License plate protection frame

(76) Inventor: Steve Parenti, Newark, CA (US)

Correspondence Address: John P. Wooldridge, 252 Kaipii PI., Kihci, HI, 96753, US

(21) Appl. No.: 11/053,354

(22) Filed: Feb. 4, 2005

Related U.S. Application Data
(63) Continuation-in-part of application No. 10/282,078, filed on Oct. 28, 2002, now Pat. No. 6,892,483.

(51) Int. Cl. G09F 7/00

(52) U.S. Cl. 40/201

(57) ABSTRACT

A tamper resistant locking mechanism has a cylinder-lock receiver that is fixedly attached to an object frame that holds an object a user desires to be secured. An example of the object frame is the license plate frame. Other object frames include a frame for a painting or other work of art. The cylinder lock receiver is formed such that it has a depth that is sufficient so that the head of cylinder lock is recessed within cylinder lock receiver. A license plate frame incorporates the tamper resistant locking mechanism.

This is a continuation-in part of U.S. patent application Ser. No. 10/282,078 titled: “Reversible Locking License Plate and Registration Sticker Tag Protection Frame,” filed Oct. 28, 2002, incorporated herein by reference.

### BACKGROUND OF THE INVENTION

1. Field of the Invention

The present invention relates to devices configured to protect a license plate and more specifically, to a license plate frame having a locking protection mechanism.

2. Description of Related Art

The use of vehicle license plate mounts and registration sticker protectors are known in the prior art Such vehicle license plate mounts and registration sticker protectors consist of structural configurations that are familiar, expected and obvious.

Known prior art includes U.S. Pat. Nos. 4,144,729, 4,223,542, 5,839,303, 4,506,528, 4,655,060, 4,788,840, 5,199,286, 5,299,721, 5,487,288, 5,659,986, 5,012,602, 5,404,664, 5,392,619, 5,027,537, 4,182,062, 5,623,776, 5,381,618, 5,488,790, 4,314,417, 5,896,685, 6,385,876, 6,286,238 and U.S. Pat. No. Des. 308,849.

In these respects, the reversible locking license plate and registration sticker tag protection frame assembly of the parent application substantially departs from the conventional concepts and designs of the prior art, and in so doing provides an apparatus primarily developed for the purpose of preventing theft of a vehicular license plate and the registration sticker. The present invention provides further improvements over the prior art

### SUMMARY OF THE INVENTION

An object of the present invention is to provide a tamper resistant locking mechanism.

It is an object of the present invention to provide a license plate frame that will prevent theft of a license plate.

It is another object of the invention to provide a license plate frame that will prevent theft of a license plate registration sticker.

These and other objects will be apparent based on the disclosure herein.

The locking license plate and registration sticker tag protection frame of the present invention includes a license plate frame comprising a heavy material frame. Removable locking unbreakable windows are attachable to the frame and protect the registration tags regardless of which of the four corners of the license plate to which the tag may be affixed. This prevents the removal of the registration tags by unauthorized persons.

A portion of the license plate frame may be designed to bear an engraved message, and can be wired into the vehicle tail light or stop light system so that the message will light up when the vehicle lights are turned on. Other embodiments provide places for sticker decals, such as auto dealerships or sports logos.

In a basic embodiment of the invention, attached to a license plate frame are two removable and lockable windows that are each covered with a translucent material. An open portion is provided. Through holes are provided through four places in the frame. To attach the frame to an automobile license plate mounting port or bracket, a back bar or receiver bar with two threaded holes is placed behind the automobile license plate mounting port Alternately, but less secure, threaded machine nuts may be placed behind the mounting bracket The license plate frame is placed on the front side of the automobile license plate mounting bracket so that the through holes of the frame align with the threaded holes of the receiver bar (or nuts). A pair of screws pass through holes in the frame, through the mounting bracket and into the threaded holes of the back bar to secure the frame to the automobile such that one of the windows will cover the registration sticker.

To prevent theft, at least one (preferably two) removable locking window is provided that covers the through holes of the frame. The locking window includes a hollow receptor for a cylinder lock. A laterally machined portion (e.g., a slot) is provided in hollow receptor to allow passage of the lock pin of the cylinder lock. A cover plate may be used to cover the unused through holes of the frame. This entire structure may be reversed top to bottom for jurisdictions that provide for registration stickers on the bottom of the license plate.

As mentioned above, the cylinder lock includes a lock pin and the hollow cylinder lock receptor includes a machined out portion to receive the lock pin. It is advantageous that the machined out portion be as small as possible, and yet large enough to fully receive the lock pin. When the key for a cylinder lock is turned to the open position, which herein is the position where the lock pin is pulled into the cylinder lock, the cylinder lock may be inserted or withdrawn from the hollow cylinder lock receptor. When the key is disengaged after the cylinder lock is inserted into the hollow receptor, the lock pin is received to extend into the machined out portion of the hollow receptor such that the cylinder lock is retained in the hollow receptor. Thus, each cylinder lock cannot be removed without its key and the screw behind the respective lock is inaccessible, preventing removal of the license plate frame and the registration sticker. The invention provides for enhancements to the license plate frame and the locking bar such as lighting and engraving.

Another embodiment of the frame prevents theft of the license plate but does not provide protection for the stickers. The hollow cylinder lock receptors are fabricated integrally with the frame. A tamper-resistant cylinder lock (TRCL) is an added enhancement that is achieved with the inclusion of modifications to the cylinder lock receptor and the cylinder lock. These modifications prevent tampering with the cylinder lock. Embodiments of the TRCL can be used on all of the license plate frames discussed in the present case and the parent patent, and can be used in a large array of other applications that require locks.

### BRIEF DESCRIPTION OF THE DRAWINGS

The accompanying drawings, which are incorporated into and form part of this disclosure, illustrate embodiments of the invention and together with the description, serve to explain the principles of the invention.

FIG. 1A shows a side view of a tamper resistant locking mechanism of the present invention.

FIG. 1B shows a license plate embodiment of the object frame.

FIGS. 2A-C show an exemplary license plate frame that incorporates a tamper resistant locking mechanism of the present invention.

FIGS. 3A-3C show an embodiment of the invention that protects a license plate and includes removable locking registration sticker tag protection windows.

### DETAILED DESCRIPTION OF THE INVENTION

The invention is a locking license plate frame. Some embodiments include a registration sticker tag protector. Some embodiments are reversible so that the registration sticker tag protector can be used to protect tags in either or both of the bottom left and right corners of a license plate. The various embodiments can be made from a wide variety of materials, e.g., aluminum, plastic, metal or moldable materials. In one embodiment, the license plate frame comprises a heavy material frame and the removable tag protector includes a translucent window made of, e.g., glass, plastic or polycarbonate such as Lexan®. The windows are configured to protect the registration tags regardless of which of the four corners of the license plate to which the tag may be affixed. This prevents the removal of the registration tags by unauthorized persons.

Lexan®, which is a polycarbonate, has an extremely high impact resistance and is transparent Polycarbonates have 250 times the impact strength of glass and 30 times the impact of acrylic. Maintenance such as cleaning and scratch removal is lower also. Lexan® is manufactured by the General Electric Company. GE also holds numerous patents directed to polycarbonates. Lexan® is designed to be the most UV/abrasion-resistant polycarbonate on the market, and is considered virtually unbreakable.

As an esthetic enhancement to the present invention, a portion of the license plate frame may be designed so that a message may be engraved thereon, and can be wired into the vehicle tail light or stop light system so that the message will light up when the vehicle lights are turned on. Other embodiments provide places for sticker decals, such as auto dealerships or sports logos.

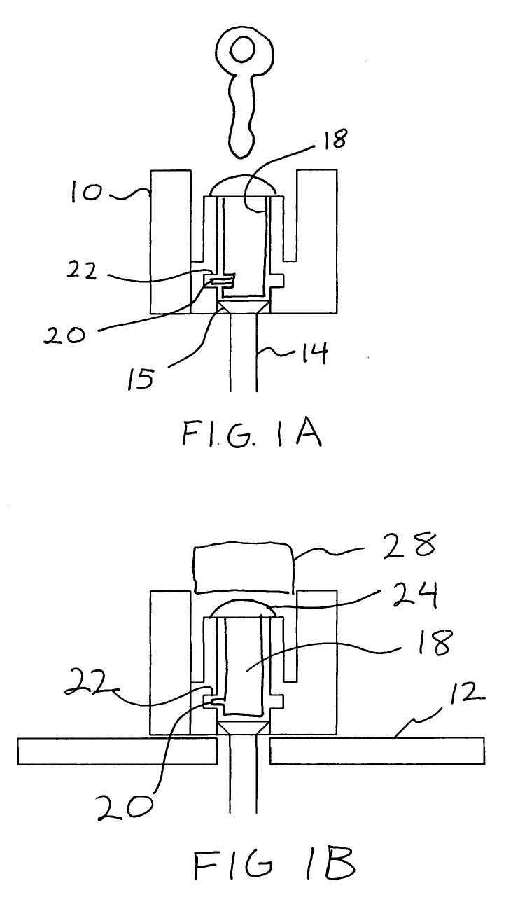

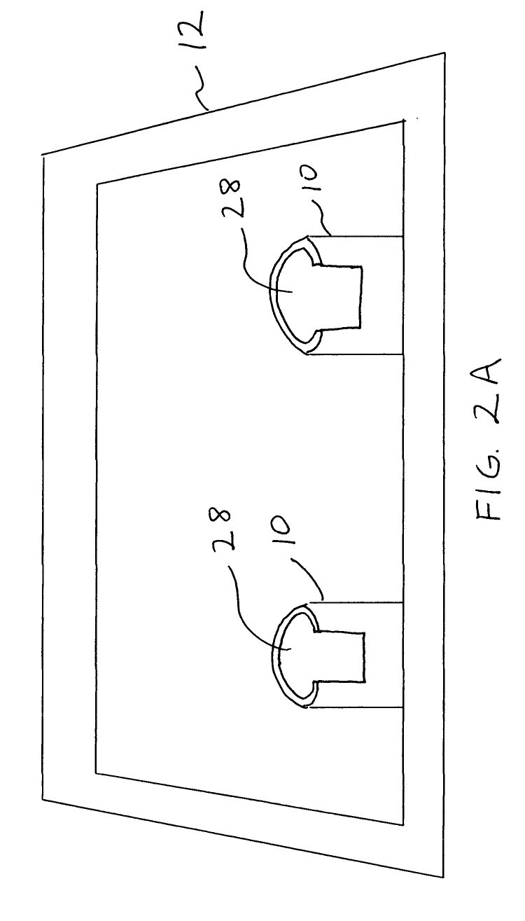

FIG. 1A shows a side view of a tamper resistant locking mechanism of the present invention. Cylinder-lock receiver 10 is fixedly attached to an object frame that holds an object desired to be secured. For example, one embodiment of the object frame is the license plate frame 12 shown in FIG. 1B. Other object frames include a frame for a painting or other work of art. Many other object frames will be apparent to those skilled in the art based on the disclosure herein. To effect the locking mechanism, a screw or a bolt 14, usually having a head 15 larger than the diameter of the screw's threaded portion is inserted into the cylinder-lock receiver, which is fixedly attached to the object frame as discussed above. The bolt 14 is further passed through a through-hole that is located in the object frame. The bolt is threaded into a threaded hole that is located in an object frame mount (not shown), or in some case, continues to extend through a through-hole also located in the object frame mount In the embodiment where the object frame is a license plate frame, an embodiment of the object frame mount is part of or affixed to an automobile bumper. The bumper may have a predrilled threaded hole to receive the bolt, or the hole may be a through-hole and then a nut can be placed on the end of the bolt to secure it in place.

Once the bolt 14 is secured and tightenedd, a cylinder lock 18 is placed into the cylinder-lock receiver 10. Cylinder lock 18 includes a lock pin 20 that extends out of the cylinder lock when the key 22 is turned in one direction. The lock pin is retracted back into the cylinder lock when the key is turned in the other direction. Cylinder-lock receiver 10 includes a notch 22 configured to receive the lock pin when it is in the extended position, thus rendering bolt 14 inaccessible.

Several embodiments provide means to render the cylinder lock to be tamper resistant In one embodiment, cylinder lock receiver 10 is formed such that it has a depth that is sufficient so that the head 24 of cylinder lock 18 is recessed within cylinder lock receiver 10. In another embodiment, the cylinder lock has a length that prevents it from extending out of the receiver 10. Still another embodiment combines an increased receiver depth with a reduced lock length to provide the tamper resistant aspect A vandal or thief would find it more difficult to tamper with a recessed cylinder lock than a non-recessed cylinder lock. Embodiments of the cylinder lock receiver include a lip 26 configured to fit under head 24 to allow the placement of a dust cap 28 over head 24. Cylinder locks are known in the art, and may be purchased, e.g., from Pioneer Hardware Co. LTD. located in Taiwan. Other types of cylinder locks are usable in the present invention.

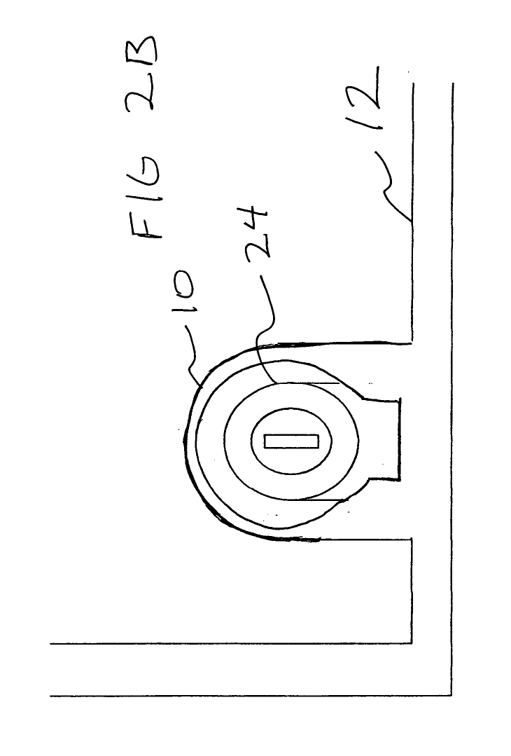

FIGS. 2A-C show an exemplary license plate frame that incorporates a tamper resistant locking mechanism of the present invention. In this example, the cylinder lock receivers 10 are integrally molded to the frame 12. This frame is reversible to protect the registration tags in any desired corner of a license plate. FIG. 2A shows an oblique view of the frame 12 with cutaway sections that show the dust caps 28, which covers the cylinder locks. FIG. 2B shows a corner of the frame 12 with a dust cap 28 removed, revealing the recessed cylinder lock 24 seated within the cylinder lock receiver 10. FIG. 2C shows the frame 12 and receiver 10 with both the dust cap and the cylinder lock removed, revealing the through hole and the notch 22.

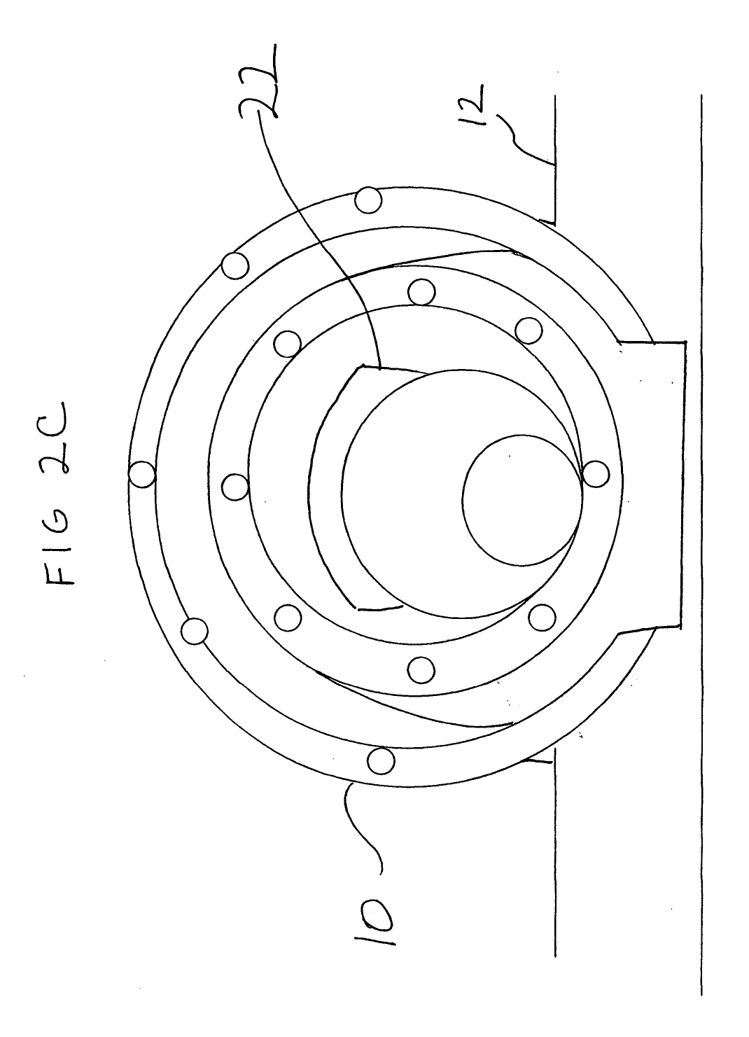

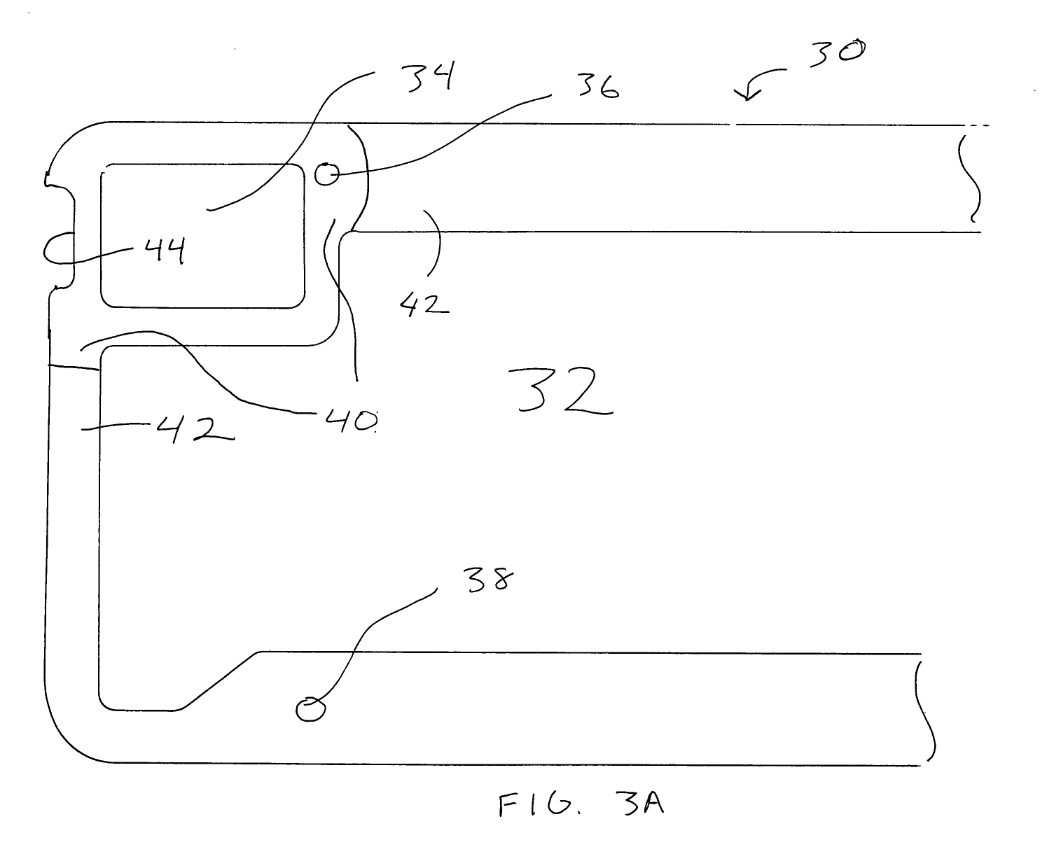

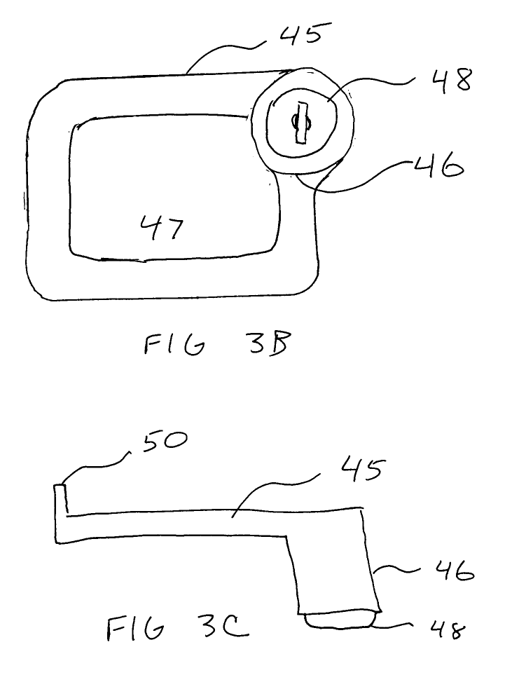

FIGS. 3A-3C show an embodiment of the invention that protects a license plate and includes removable locking registration sticker tag protection windows. FIG. 3A shows the left portion of a frame 30 with a license plate window opening 32, a sticker tag protection opening 34, and two through holes 36 and 38. The portion 40 of the frame 30 is recessed with respect to the remaining portion 42. The frame includes a keyed section 44. The right portion (not shown) of frame 30 preferably includes another sticker tag protection window, through hole and keyed section. FIG. 3B shows the left side removable locking registration sticker tag protection window frame 45, which includes a cylinder lock receiver 46 and an cylinder lock 48, as taught in this and the parent application. The right side removable locking registration sticker tag protection window frame (not shown) is similar to window frame 45; however, the lock is located in its upper left corner, rather than the upper right corner as shown in FIG. 3B. The removable locking registration sticker tag protection window frame 45 includes a protective translucent sheet 47 of material, e.g., Lexan®, to allow the registration tags to be seen, but to prevent their removal. FIG. 3C shows a top view of the frame 45 with a key portion 50, which fits recessed portion 40 of frame 30. This frame is reversible to protect the registration tags in any desired corner of a license plate.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

1. An apparatus, comprising:
an object frame having a through-hole; and
a cylinder lock receiving portion fixedly attached to said object frame over said through-hole, wherein said receiving portion includes a notch configured to receive the lock pin of a cylinder lock inserted within said receiving portion when said lock pin is in an extended position, wherein when a bolt is inserted into said receiving portion and through said through-hole of said object frame, said cylinder lock will render said bolt inaccessible.

2. The apparatus of claim 1, further comprising means for recessing the cylinder lock within said receiver portion.

3. The apparatus of claim 2, wherein said means are selected from the group consisting of (i) an extended receiving portion depth, (ii) a reduced cylinder lock length and (iii) and combination of (i) and (ii).

4. The apparatus of claim 1, wherein said receiver portion include a dust cap lip.

5. The apparatus of claim 4, further comprising a dust cap that fits over a cylinder lock inserted into said receiver portion, wherein said dust cap fits onto said dust cap lip.

6. The apparatus of claim 1, further comprising a cylinder lock for insertion into said receiver portion.

7. The apparatus of claim 1, further comprising a bolt for insertion within said receiver portion and through said through hole.

8. The apparatus of claim 1, wherein said object frame comprises a license plate frame.

9. The apparatus of claim 1, wherein said frame retains an object that is desired to be protected.

10. An apparatus, comprising:
a license plate frame comprising a first opening configured to allow an unobstructed view of the license plate, wherein said frame comprises a second opening and a third opening, each configured to allow an unobstructed view of a registration sticker tag affixed to the license plate;
a first removable locking registration sticker tag protection window assembly (first assembly) comprising a translucent material configured for placement over said second opening, wherein said first assembly comprising a first cylinder lock receiving portion and a first cylinder lock located therein, wherein said first cylinder lock comprises a first locking pin and said first cylinder lock receiving portion includes a first notch configured to receive said first locking pin; and
a second removable locking registration sticker tag protection window assembly (second assembly) comprising said translucent material configured for placement over said third opening, wherein said second assembly comprising a second cylinder lock receiving portion and a second cylinder lock located therein, wherein said second cylinder lock comprises a second locking pin and said second cylinder lock receiving portion includes a second notch configured to receive said second locking pin.
